(19) United States
(12) Patent Application Publication
(10) Pub. No.: US 2004/0075654 A1
(43) Pub. Date: Apr. 22, 2004

(54) 3-D digital image processor and method for visibility processing for use in the same

(75) Inventors: Chien-Chung Hsiao, Penghu (TW); Kuo-Wei Yeh, Miaoli (TW)

Correspondence Address: LOWE HAUPTMAN GOPSTEIN, GILMAN & BERNER, LLP, Suite310, 1700 Diagonal Road, Alexandria, VA, 22314, US

(73) Assignee: SILICON INTEGRATED SYSTEMS CORP.

(21) Appl. No.: 10/270,681

(22) Filed: Oct. 16, 2002

(51) Int. Cl. G06T 1/00

(52) U.S. Cl. 345/418

(57) ABSTRACT

A three-dimensional (3-D) digital image processor and a method for processing a visibility for use in a displaying procedure of a 3-D digital image are disclosed. The 3-D digital image processor includes a depth map generator, a memory device and a rendering engine. The method includes steps of presetting a depth map according to a plurality of pixels received, the depth map storing the pixels and reference depths corresponding thereto, and receiving a pixel data and proceeding a visibility test with reference to the depth map, thereby determining whether to proceed a rendering operation on the 3-D digital image by the pixel data.

### FIELD OF THE INVENTION

The present invention relates to a three-dimensional (3-D) digital image processor, and more particularly to a three-dimensional (3-D) digital image processor in a personal computer. The present invention also relates to a method for processing a visibility for use in a three-dimensional (3-D) digital image processor in a personal computer.

### BACKGROUND OF THE INVENTION

In 3-D graphics applications, an object in a scene is represented by 3-D graphical model. Using a polygon mesh, for example, the surface of an object is modeled with several interconnected polygons. The rendering process typically begins by transforming the vertices of the geometric primitives (polygons) to prepare the model data for the rasterizing process. Rasterizing generally refers to the process of computing a pixel value for a pixel in the view space based on data from the geometric primitives that project onto or cover the pixel.

Please refer to FIG. 1 which is a functional block diagram illustrating a conventional 3-D graphics engine. The 3-D graphics engine includes a transform-lighting engine 11 for geometric calculation, a setup engine 12 for initializing the primitives, a scan converter 13 for deriving pixel coordinates, a color calculator 14 for generating smooth color, a texture unit 15 for processing texture, an alpha blending unit 16 for generating transparent and translucent effect, a depth test unit 17 for pixel-based hidden surface removal, a display controller 18 for accurately displaying images on a monitor 21, and so on. The 3-D graphics engine receives and executes the commands stored in the command queue 10 and the memory controller 19 accesses a graphics memory 20 via a memory bus. The command queue 10 is a first-in first-out (FIFO) unit for storing command data, received from a controller 1 via a system bus.

In a given 3-D graphics scene, a number of polygons may project onto the same area of the projection plane. As such, some primitives may not be visible in the scene. The depth test unit 17 described in the above is used for removing the pixel-based hidden surface. Hence, many hidden surface removal algorithms are developed. One of the well-known algorithms is the Z-buffer algorithm, which uses a Z-buffer to store the depth value of each drawing point. The kernel of Z-buffer algorithm involves a depth comparison mechanism for each incoming point's depth value and the depth value stored in the Z-buffer. For a point (x, y) on the facet, the depth value can be derived by an interpolation between the depth values of vertices of the facet. The corresponding depth value, with coordinate (x, y), is retrieved from the Z-buffer. A depth test is invoked to determine which one is closer to the viewer by comparing the two depth values. The Z-buffer is then updated with the closer depth value. Therefore, the Z-buffer reflects the status of the closest depth values so far encountered for every point in the projection plane. For instance, assume that the viewer is positioned at the origin with z coordinate equal to zero. Moreover, the viewing direction is toward the positive z-axis. Then, the Z-buffer is used to hold the smallest z value so far encountered for each drawing point.

The Z-buffer algorithm is the simplest algorithm to implement hidden surface removal in modern computer graphics system. The pseudocode for the Z-buffer algorithm is shown below.

```
For (each polygon) {
    For (each pixel in polygon's projection) {
        Calculate pixel's z value (source-z) at coordinates (x, y);
        Read destination-z from Z-buffer (x, y);
        If (source-z is closer to the viewer)
            Write source-z to Z-buffer (x, y);
    }
}
```

A major problem of modern 3-D applications is known as overdraw. Most graphics processors have no way of knowing what parts of the scene will be visible and what parts will be covered until they begin the rendering process. The kernel of Z-buffer algorithm involves a depth comparison mechanism for each incoming pixel's depth value and the depth value stored in the Z-buffer. In the depth comparison process, many pixels will be written to the frame buffer, then overwritten by new pixels that are closer to the viewer. Overdraw is the term for this overwriting of pixels in the frame buffer. A measure of the amount of overdraw in a scene is called depth complexity, which represents the ratio of total pixels rendered to visible pixels. For example, if a scene has a depth complexity of 4, this means 4 times as many pixels were rendered as were actually visible on the screen. In a complex 3-D scene, a large amount of objects are overlapped. In the viewpoint of the depth comparison mechanism, the polygon (or primitive) in front-to-back order is preferred. The pixel with larger depth value (far away from the viewer) will be discarded after the depth comparison processed because an overlapped pixel with smaller depth value (closer to the viewer) is already drawn. Otherwise, the new pixel will be rendered and overwrite the current depth value and color values in the depth buffer and frame buffer, respectively, for the corresponding pixel location. It is apparent that the rendering process consumes a great deal of processing and memory resources in the invisible pixels if they are not discarded in the early stage of graphics pipeline. FIG. 2 is an example of top-viewed graphics scene. The viewer's field-of-view is indicated in dot line and the visible objects in the scene are represented by black dot lines. As shown in FIG. 2, most of the objects in this example scene are hidden. It dramatically reduces the efficiency of graphics rendering systems because of the problem of overdraw.

Conventional graphics hardware tries to overcome this problem by performing a Z-sort, which eliminates some of the redundant information. The aforesaid method eliminates required memory bandwidth of performing pixel by pixel visibility test, but it can not overcome the problem of overdrawing and still leaves substantial unnecessary computations and memory requirements. For example, if the graphics primitives are drawn in a back-to-front (far-to-near) order, the mass of pixels passed the visibility test and the undesirable overdraw occurred.

The Z-buffer algorithm is easy to implement in either software or hardware and no presorting is necessary. The Z-buffer reflects the status of closest depth values so far encountered for every point in the projection plane. According to the foregoing, however, the conventional Z-buffer algorithm cannot solve the problem of overdrawing, if objects are rendered in back-to-front order. Therefore, the purpose of the present invention is to develop a three-dimensional (3-D) digital image processor in a personal computer and a method for processing a visibility for use in a three-dimensional (3-D) digital image processor to deal with the above situations encountered in the prior art.

### SUMMARY OF THE INVENTION

According to an aspect of the present invention, there is provided a method for processing a visibility for use in a displaying procedure of a three-dimensional (3-D) digital image. The method includes steps of presetting a depth map according to a plurality of pixels received, the depth map storing the pixels and reference depths corresponding thereto, and receiving a pixel data and proceeding a visibility test with reference to the depth map, thereby determining whether to proceed a rendering operation on the 3-D digital image by the pixel data.

In accordance with the present invention, the visibility test includes steps of accessing a two-dimensional (2-D) coordinate and a depth value included in the pixel data, inputting the depth map according to the 2-D coordinate to generate a reference depth value corresponding thereto, and comparing the depth value and the reference depth value to determine which one is closer to a viewer's depth value. The 3-D digital image is not proceeded the rendering operation by the pixel data when the reference depth value is closer to the viewer's depth value.

In accordance with the present invention, the presetting the depth map step includes steps of inputting 2-D coordinates of the pixels to the depth map to obtain corresponding original reference depth values, and proceeding a comparing and updating operation on the original reference depth values and the depth values of the pixels, respectively, thereby determining whether to update the original reference depth values of the depth map.

In accordance with the present invention, the comparing and updating operation includes steps of comparing one of the original reference depth values and the corresponding one of the depth values of the pixels to determine which one is closer to the viewer's depth value, updating the original reference depth value of the depth map with the depth value of the pixel when the depth value of the pixel is closer to the viewer's depth value, and maintaining the original reference depth value when the original reference depth value is closer to the viewer's depth value.

In accordance with the present invention, the presetting the depth map step further includes step of proceeding the comparing and updating operation after confirming the pixel does not need to proceed another visibility test. Preferably, another visibility test is an alpha blending test.

According to another aspect of the present invention, there is provided a three-dimensional (3-D) digital image processor comprising a depth map generator presetting a depth map according to a plurality of pixels received, wherein the depth map stores a corresponding relation between two-dimensional (2-D) coordinates and depth values of the pixels, a memory device in communication with the depth map generator for storing the depth map therein, and a rendering engine receiving a pixel data and proceeding a rendering operation on a corresponding pixel of the 3-D digital image, the rendering engine proceeding a visibility test with reference to the depth map stored in the memory device, thereby determining whether to proceed the rendering operation on the 3-D digital image by the pixel data.

In accordance with the present invention, the visibility test includes steps of accessing a two-dimensional (2-D) coordinate and a depth value included in the pixel data, inputting the depth map according to the 2-D coordinate to generate a reference depth value corresponding thereto, and comparing the depth value and the reference depth value to determine which one is closer to a viewer's depth value. The rendering engine is controlled not to proceed the rendering operation by the pixel data when the reference depth value is closer to the viewer's depth value.

In accordance with the present invention, the depth map generator inputs 2-D coordinates of the pixels to the depth map to obtain corresponding original reference depth values and then proceeds a comparing and updating operation on the original reference depth values and the depth values of the pixels, respectively, thereby determining whether to update the original reference depth values of the depth map.

In accordance with the present invention, the comparing and updating operation executed by the depth map generator includes steps of comparing one of the original reference depth values and the corresponding one of the depth values of the pixels to determine which one is closer to the viewer's depth value, updating the original reference depth value of the depth map with the depth value of the pixel when the depth value of the pixel is closer to the viewer's depth value, and maintaining the original reference depth value when the original reference depth value is closer to the viewer's depth value.

In accordance with the present invention, the depth map generator further executes step of proceeding the comparing and updating operation after confirming the pixel does not need to proceed another visibility test. Preferably, another visibility test is an alpha blending test.

In accordance with the present invention, the 3-D digital image processor further includes a frame buffer in communication with the rendering engine for writing in the pixel data when the rendering engine proceeds the rendering operation.

### BRIEF DESCRIPTION OF THE DRAWINGS

The present invention may best be understood through the following description with reference to the accompanying drawings, in which:

FIG. 1 is a functional block diagram illustrating a conventional 3-D graphics engine;

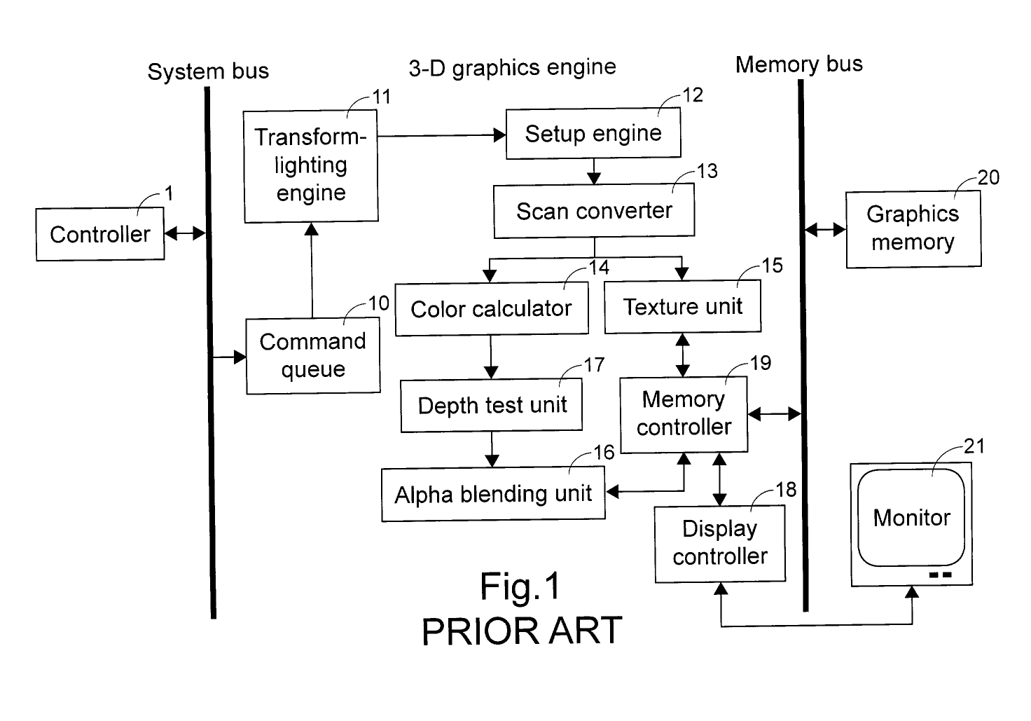

FIG. 2 is a top view illustrating a exemplification of a 3-D scene;

FIG. 3 is a functional block diagram illustrating a preferred embodiment of a 3-D graphics engine according to the present invention;

FIG. 4 is a flowchart illustrating a preferred embodiment of a comparing and updating operation on a depth map in the primary stage according to the present invention; and

FIG. 5 is a flowchart illustrating a preferred embodiment of a comparing and updating operation on a depth map in the rendering stage according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

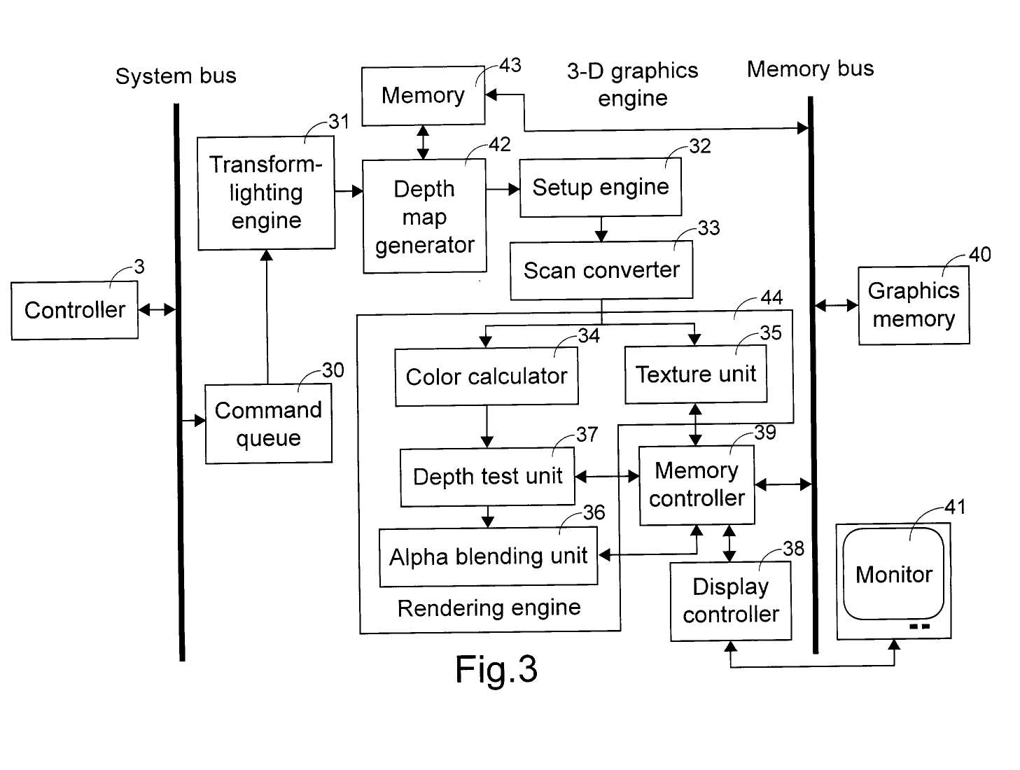

Please refer to FIG. 3 which is a functional block diagram illustrating a conventional 3-D graphics engine. The 3-D graphics engine includes a transform-lighting engine 31 for geometric calculation, a setup engine 32 for initializing the primitives, a scan converter 33 for deriving pixel coordinates, a color calculator 34 for generating smooth color, a texture unit 35 for processing texture, an alpha blending unit 36 for generating transparent and translucent effect, a depth test unit 37 for pixel-based hidden surface removal, and a display controller 38 for accurately displaying images on a monitor 41. A rendering engine 44 consists of the color calculator 34, the texture unit 35, the alpha blending unit 36 and the depth test unit 37. The 3-D graphics engine receives and executes the commands stored in the command queue 30 and the memory controller 39 accesses a graphics memory 40 via a memory bus. The command queue 30 is a first-in first-out (FIFO) unit for storing command data, received from a controller 3 via a system bus.

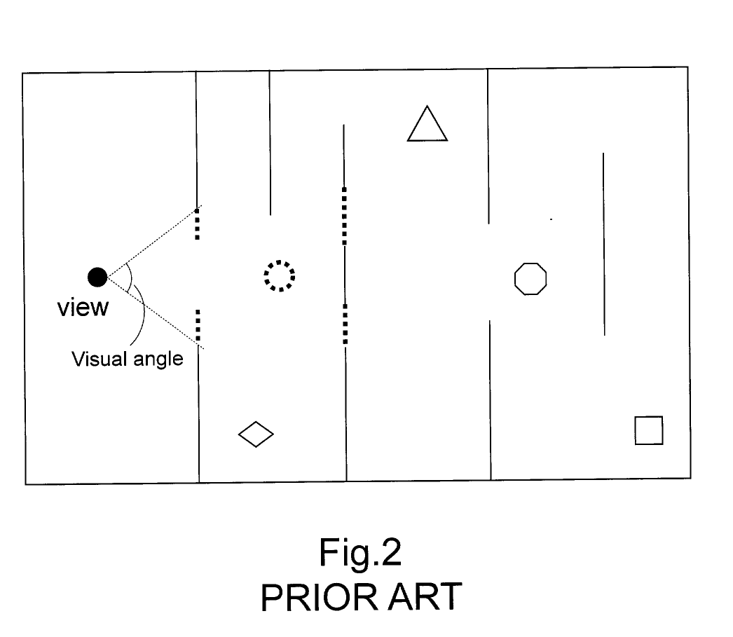

The present invention is characterized that a depth map generator 42 is disposed between the transform-lighting engine 31 and the setup engine 32. The depth map generator 42 is used for accessing a depth map, which consists of a two-dimensional (2-D) coordinate (x, y) and a depth value Z, of each pixel data processed by the transforming-lighting engine 31. The depth map is used for storing and indicating the corresponding relation between the 2-D coordinate (x, y) and the corresponding reference depth value Zr of each pixel on the frame. Since most of the 3-D image scenes consist of plural front-and-rear overlapping objects (As shown in FIG. 2). For obtaining the correct distribution of the whole 3-D image scene, the original reference depth value Zr and the pixel's depth value proceed a comparing and updating operation thereon when the depth map generator 42 receives the incoming pixel data having the same 2-D coordinate (x, y) and the different depth value in the follow-up procedure. Accordingly, it is determined whether to update the original reference depth value of the depth map. The comparing and updating operation includes steps of: (a) comparing the original reference depth value with the incoming pixel's depth value to determine which one is closer to a viewer's depth value; (b) when the incoming pixel's depth value is closer to the viewer's depth value, the original reference depth value of the depth map is updated with the incoming pixel's value to become a new reference depth value; and (c) when the original reference depth value is closer to the viewer's depth value, the original reference depth value of the depth map is not updated.

In such way, after all pixels have been processed by the depth map generator 42, an entire depth map is obtained. The depth map is stored in a temporary memory, which is defined in the graphics memory 40. During the follow-up rendering operation, the unnecessary overdraw operation can be omitted by referring to the depth map. Thoroughly, when the rendering operation is performed, each of the incoming pixel data proceeds a visibility test by using the entire depth map, thereby determining whether to proceed the rendering operation on the pixel of the 3-D digital image by the pixel data. The visibility test includes steps of: (a) accessing a 2-D coordinate and a depth value included in the pixel data; (b) inputting the depth map to obtain a reference depth value according to the 2-D coordinate; and (c) comparing the reference depth value with the depth value to determine which one is closer to the viewer's depth value, when the reference depth value is closer to the viewer's depth value, the pixel data is not used to proceed the rendering operation.

When the above comparing and updating operation is executed, only the 2-D coordinate and the depth value of the pixel data are required. The other information such as texture, color, . . . , is passed over, so it is dramatically to reduce the consumption of the system calculation ability and the occupation of the memory bandwidth. However, a pixel is determined to be drawn or discarded depends not only the visibility test but also other test such as the alpha blending test or the operation of transparency. The alpha blending test compares an alpha value of the incoming pixel data with a reference alpha value. If the test fails, then the incoming pixel is discarded and will not update the stored in the frame buffer and the Z-buffer, which are defined in the graphics memory 40.

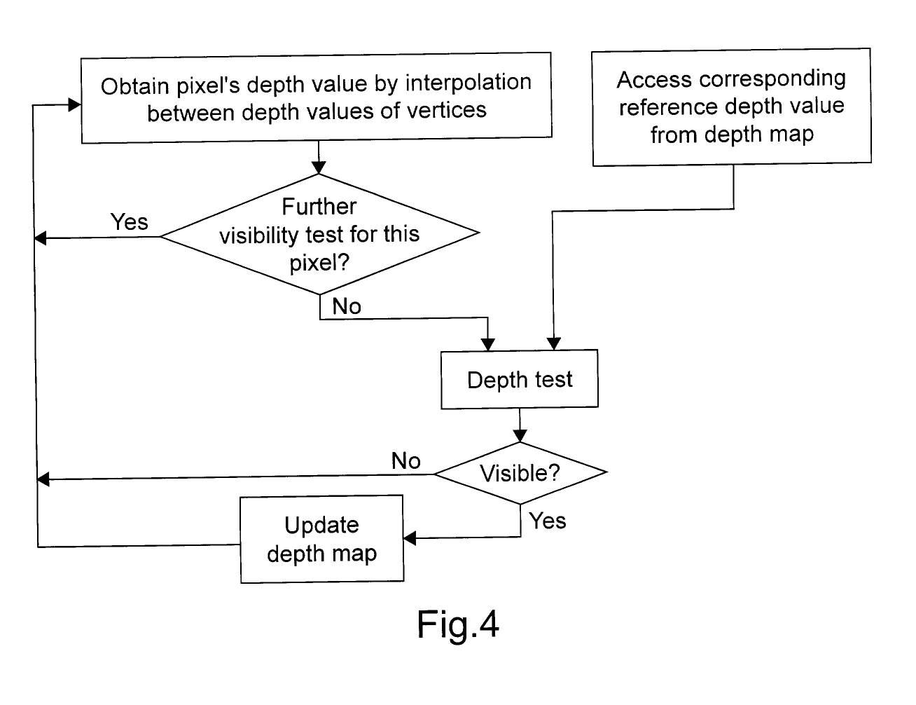

The problem is that the incoming alpha values are derived from operations such as texture mapping and alpha blending. The texture mapping requires lots of texture data accessing from a texture buffer. The alpha blending requires destination frame buffer data for blending the source color and destination color. Consider of the alpha-blending operation in a 3-D graphics scene, the foreground object is blending with the drawn background objects. Since the rendering operation for every pixel is not only dependence on the depth value, the depth map described in the above cannot conform to practical demand. For solving this problem, a preferred embodiment of the comparing and updating operation of the described depth map is shown in a flowchart of FIG. 4. For a point (x, y) on the facet, the depth value can be derived by an interpolation between the depth values of vertices of the facet. The reference depth value of the coordinate (x, y) is retrieved from the depth map. A depth test is invoked to determine which one is closer to the viewer by comparing the two depth values. The depth map is then updated with the closer depth value. If a pixel, which is determined to be drawn or discarded, depends not only the depth test but also other test such as the alpha blending test, the reference depth value of the coordinate (x, y) in the depth map will not be modified, such that the visibility testing is determined in the rendering stage.

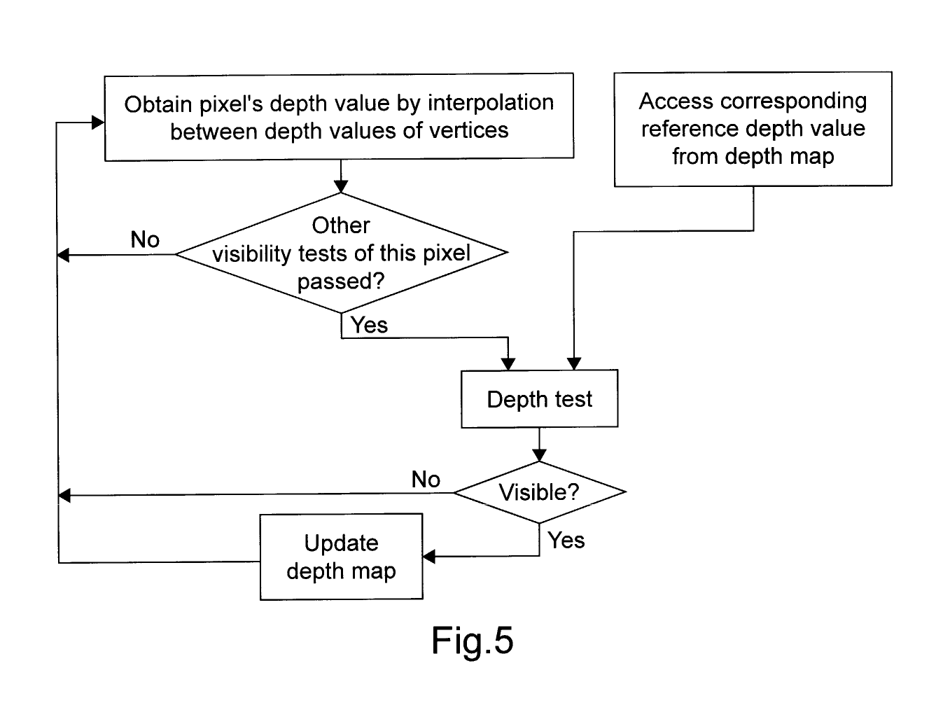

Please refer to FIG. 5 which is a flowchart illustrating a preferred embodiment of a comparing and updating operation on a depth map in the rendering stage according to the present invention. This flowchart is applied for the pixel requiring to proceed other visibility tests such as the alpha blending test and the operation of transparency. After these visibility tests, the comparing and updating operation of the depth test is performed again. It is unnecessary to update most data of the original depth map. Therefore, it still can save a large number of the system resources and the memory bandwidths.

To sum up, the present invention provides a reference for the rendering engine to execute the rendering operation by using the depth map, which is preset by a little information and stored in the memory. It can omit unnecessary overdraw operations, save lots of the system resources and the memory bandwidths, and further increase the speed of displaying the scene.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for processing a visibility for use in a displaying procedure of a three-dimensional (3-D) digital image, comprising steps of:
presetting a depth map according to a plurality of pixels received, said depth map storing said pixels and reference depths corresponding thereto; and
receiving a pixel data and proceeding a visibility test with reference to said depth map, thereby determining whether to proceed a rendering operation on said 3-D digital image by said pixel data.

2. The method for visibility processing according to claim 1 wherein said visibility test includes steps of:
accessing a two-dimensional (2-D) coordinate and a depth value included in said pixel data;
inputting said depth map according to said 2-D coordinate to generate a reference depth value corresponding thereto; and
comparing said depth value and said reference depth value to determine which one is closer to a viewer's depth value, wherein said 3-D digital image is not proceeded said rendering operation by said pixel data when said reference depth value is closer to said viewer's depth value.

3. The method for visibility processing according to claim 1 wherein said presetting said depth map step includes steps of:
inputting 2-D coordinates of said pixels to said depth map to obtain corresponding original reference depth values; and
proceeding a comparing and updating operation on said original reference depth values and said depth values of said pixels, respectively, thereby determining whether to update said original reference depth values of said depth map.

4. The method for visibility processing according to claim 3 wherein said comparing and updating operation includes steps of:
comparing one of said original reference depth values and the corresponding one of said depth values of said pixels to determine which one is closer to said viewer's depth value;
updating said original reference depth value of said depth map with said depth value of said pixel when said depth value of said pixel is closer to said viewer's depth value; and
maintaining said original reference depth value when said original reference depth value is closer to said viewer's depth value.

5. The method for visibility processing according to claim 3 wherein said presetting said depth map step further includes step of proceeding said comparing and updating operation after confirming said pixel does not need to proceed another visibility test.

6. The method for visibility processing according to claim 5 wherein said another visibility test is an alpha blending test.

7. A three-dimensional (3-D) digital image processor comprising:
a depth map generator presetting a depth map according to a plurality of pixels received, wherein said depth map stores a corresponding relation between two-dimensional (2-D) coordinates and depth values of said pixels;
a memory device in communication with said depth map generator for storing said depth map therein; and
a rendering engine receiving a pixel data and proceeding a rendering operation on a corresponding pixel of said 3-D digital image, said rendering engine proceeding a visibility test with reference to said depth map stored in said memory device, thereby determining whether to proceed said rendering operation on said 3-D digital image by said pixel data.

8. The 3-D digital image processor according to claim 7 wherein said visibility test includes steps of:
accessing a two-dimensional (2-D) coordinate and a depth value included in said pixel data;
inputting said depth map according to said 2-D coordinate to generate a reference depth value corresponding thereto; and
comparing said depth value and said reference depth value to determine which one is closer to a viewer's depth value, wherein said rendering engine is controlled not to proceed said rendering operation by said pixel data when said reference depth value is closer to said viewer's depth value.

9. The 3-D digital image processor according to claim 7 wherein said depth map generator inputs 2-D coordinates of said pixels to said depth map to obtain corresponding original reference depth values and then proceeds a comparing and updating operation on said original reference depth values and said depth values of said pixels, respectively, thereby determining whether to update said original reference depth values of said depth map.

10. The 3-D digital image processor according to claim 9 wherein said comparing and updating operation executed by said depth map generator includes steps of:
comparing one of said original reference depth values and the corresponding one of said depth values of said pixels to determine which one is closer to said viewer's depth value;
updating said original reference depth value of said depth map with said depth value of said pixel when said depth value of said pixel is closer to said viewer's depth value; and
maintaining said original reference depth value when said original reference depth value is closer to said viewer's depth value.

11. The 3-D digital image processor according to claim 9 wherein said depth map generator further executes step of proceeding said comparing and updating operation after confirming said pixel does not need to proceed another visibility test.

12. The 3-D digital image processor according to claim 11 wherein said another visibility test is an alpha blending test.

13. The 3-D digital image processor according to claim 7 further comprising a frame buffer in communication with said rendering engine for writing in said pixel data when said rendering engine proceed said rendering operation.
